(19) United States
(12) Patent Application Publication
(10) Pub. No.: US 2017/0051988 A1
(43) Pub. Date: Feb. 23, 2017

(54) HEAT EXCHANGER WITH TURBULENCE INCREASING FEATURES

(71) Applicant: Halla Visteon Climate Control Corp., Daejeon (KR)

(72) Inventors: Orest Alexandru Dziubinschi, Dearborn, MI (US); Kastriot Shaska, Northville, MI (US); Brian James Cardwell, Ypsilanti, MI (US)

(21) Appl. No.: 14/832,067

(22) Filed: Aug. 21, 2015

(51) Int. Cl. F28F 9/02; B23P 15/26

(52) U.S. Cl. CPC F28F 9/0265; B23P 15/26

(57) ABSTRACT

An extruded multi-port tube for use in a heat exchanger comprises a main body including an outer wall and a plurality of ports formed therein, each of the ports extending longitudinally from a first end of the main body to a second end thereof and configured to convey a first fluid therethrough. The outer wall of the main body includes at least one indentation formed therein. Each of the indentations is a portion of the outer wall deformed inwardly into a hollow interior of one of the ports and configured to increase a turbulence of the first fluid as it flows from the first end to the second end of the main body to increase a heat exchange efficiency of the heat exchanger having the tube.

### FIELD OF THE INVENTION

The invention relates to a heat exchanger, and more specifically to a heat exchanger tube having internal turbulence inducing features created by externally introduced mechanical means.

### BACKGROUND OF THE INVENTION

Heat exchangers are commonly found in many systems where it is necessary for the heat energy of one fluid to be exchanged with the heat energy of another fluid for a variety of different technical reasons. The exchange of heat may be related to the utilizing of a maximum amount of available energy within the system or may in other cases be related to heating or cooling a medium that is then used to regulate a temperature of an object or an environment.

Heat exchangers typically include a plurality of heat exchanger tubes that extend between an inlet header and an outlet header. The heat exchanger tubes carry a first fluid therein while a second fluid is passed over or between the heat exchanger tubes. In some instances, a plurality of fins or other surface area increasing features may extend from one heat exchanger tube to an adjacent heat exchanger tube. The heat energy is exchanged between the two fluids via walls of the heat exchanger tubes. Hence, an efficiency of the heat exchanger is largely dependent on the ability of either of the first fluid and the second fluid to transfer heat energy to and through walls of the tubes.

One method of maximizing the heat transfer between a fluid and the wall of the tube is to increase turbulence of the fluid at a boundary between the fluid and the wall of the tube. However, highly efficient heat exchangers that promote turbulence in one of the fluids flowing through the heat exchanger often require exceedingly complex modifications to the interior of the heat exchanger tube. For example, the heat exchanger tube may be modified by addition of an internal insert that increases the turbulence of the fluid flowing therein or the heat exchanger tube may require a complex manufacturing process to introduce additional internal features for increasing the turbulence of the fluid. In either case, the cost and complexity of producing such turbulence inducing features within the heat exchanger tube may be cost prohibitive.

One form of heat exchanger that may require an increase of turbulence within the heat exchanger tube is the Transmission Oil Cooler (TOC). A common and cost effective method of forming a TOC includes extruding aluminum to form elongated multi-port tubing. However, creating additional physical features to increase the turbulence in the laminar flow of the oil used in the TOC is difficult and expensive within the multi-port extruded tube due to the use of complex and expensive manufacturing processes.

It would therefore be desirable to produce heat exchanger tubes manufactured using a low cost extrusion process while maximizing a heat transfer efficiency through the introduction of turbulence increasing features within ports of the extruded heat exchanger tubes.

### SUMMARY OF THE INVENTION

Compatible and attuned with the present invention, an extruded multi-port heat exchanger tube having at least one indentation formed in an outer wall thereof for maximizing the turbulence within each port of the heat exchanger tube has surprisingly been discovered.

In one embodiment of the invention, a tube for a heat exchanger comprises a main body including an outer wall and a plurality of ports formed therein, each of the ports extending in a longitudinal direction from a first end of the main body to a second end thereof and configured to convey a first fluid therethrough. The outer wall of the main body includes a surface deformation formed therein, wherein the surface deformation is a portion of the outer wall deformed inwardly into a hollow interior of one of the ports and configured to cause a turbulence of the first fluid as it flows from the first end to the second end of the main body.

A method of forming a tube is also disclosed. The method comprises the steps of: extruding a main body longitudinally in a first direction, wherein the extruding the main body includes a formation of at least one port therein for conveying a fluid through the main body; and deforming at least a portion of an outer wall of the main body inwardly into one of the ports to form at least one indentation in the outer wall of the main body.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawings:

FIG. 1 is front elevational view of a heat exchanger according to an embodiment of the invention;

FIG. 2 is a top perspective view of a heat exchanger tube of the heat exchanger illustrated in FIG. 1 having a plurality of indentations formed in an outer wall thereof;

FIG. 3 is a cross-sectional view of the heat exchanger tube taken along line 3-3 of FIG. 2;

FIG. 4A is a top plan view of an arrangement of the indentations according to one embodiment of the invention;

FIG. 4B is a top plan view of an alternative arrangement of the indentations according to another embodiment of the invention;

FIG. 4C is a top plan view of another alternative arrangement of the indentations according to another embodiment of the invention; and

FIG. 5 is a fragmentary front perspective view of a system for forming the heat exchanger tube illustrated in FIGS. 1-3.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

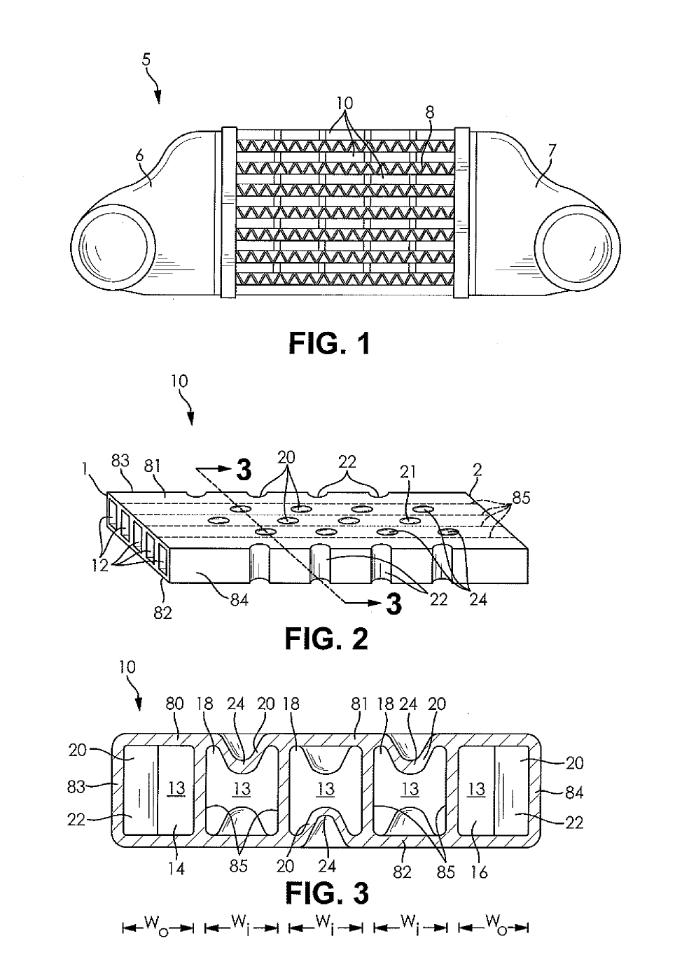

FIG. 1 illustrates a heat exchanger 5 according to an embodiment of the invention. The heat exchanger 5 may be any form of heat exchanger, including a Transmission Oil Cooler (TOC) having transmission oil of a vehicle flowing therethrough. A plurality of tubes 10 extends between an inlet tank 6 and an outlet tank 7 of the heat exchanger 5 for conveying a first fluid therethrough. The inlet tank 6 may be any structure suitable for distributing a flow of the first fluid to each of the tubes 10 for delivery to the outlet tank 7. Similarly, the outlet tank 7 may be any structure suitable for collecting and recombining the distributed flows from the plurality of tubes 10. The tubes 10 may be arranged in parallel and spaced apart from each other in a direction perpendicular to a longitudinal axis of each of the tubes 10 to allow for a second fluid to flow therebetween. Heat energy is then transferred between the first fluid and the second fluid through the wall of each of the tubes 10. In some embodiments, a plurality of surface area increasing features such as fins 8 extend between the spaced apart tubes 10 to increase a total heat exchanging surface area between the inlet tank 6 and the outlet tank 7, thereby increasing an efficiency of the heat exchanger 5.

FIGS. 2 and 3 illustrate one of the tubes 10 of the heat exchanger 5. The tube 10 may be comprised of an extruded main body including a plurality of ports 12 formed therein, wherein each of the ports 12 is a void formed in the main body during the extrusion process. Although described herein as extruded, other processes can be used to produce the tube 10 while remaining within the scope of the present invention, as desired. Each of the ports 12 extends from a first end 1 of the tube 10 to a second end 2 thereof for conveying the first fluid through the tube 10 in a longitudinal direction thereof.

The main body of the tube 10 may have a substantially rectangular cross-sectional shape as it extends from the first end 1 to the second end 2, wherein the plurality of ports 12 may be arranged linearly next to each other in an array extending in the lateral direction of the tube 10 perpendicular to the longitudinal axis thereof, as best shown in FIGS. 2 and 3. The tube 10 includes an outer wall 80 comprising a first major portion 81, a second major portion 82, a first short portion 83, and a second short portion 84. The first major portion 81 and the second major portion 82 are arranged in parallel to each other and are formed on opposing sides of the linear array of the ports 12. The first short portion 83 and the second short portion 84 are similarly arranged in parallel to each other and are formed at opposing ends of the linear array of the ports 12. A plurality of dividing walls 85 is formed between the first major portion 81 and the second major portion 82 to divide an interior of the tube 10 into the plurality of the ports 12. The first major portion 81, the second major portion 82, the first short portion 83, the second short portion 84, and the dividing walls 85 each extend along a length of the tube 10 from the first end 1 to the second end 2 thereof.

The linearly arranged and longitudinally extending broken lines shown in FIG. 2 indicate a position of the dividing walls 85 formed between adjacent ones of the ports 12 within the interior of the tube 10. The tube 10 shown in FIGS. 2 and 3 has five of the ports 12 formed therein, but the tube 10 may have any number of the ports 12 formed therein while remaining within the scope of the present invention. If the ports 12 are arranged next to each other in the lateral direction of the tube 10 as shown in FIGS. 2 and 3, the polls 12 may each have a substantially rectangular cross-sectional shape. However, it should be understood that other cross-sectional shapes of the ports 12 and the tubes 10 may be utilized while remaining within the scope of the present invention, including elliptical or circular shapes, as non-limiting examples.

The ports 12 formed in the tube 10 may be formed to have different cross-sectional flow areas depending on a position of each port 12 relative to the outer wall 80 of the tube 10. The varying cross-sectional flow areas may be selected to more evenly distribute the stresses occurring within the ports 12 due to the internal pressure of a fluid flowing through the tube 10. The ports 12 may, for example, include a first outermost poll 14 formed adjacent the first short portion 83 of the outer wall 80, a second outermost port 16 formed adjacent the second short portion 84 of the outer wall 80, and at least one inner port 18 formed between the first outermost port 14 and the second outermost port 16. The first outermost port 14 and the second outermost port 16 may be selected to have a larger or a smaller cross-sectional flow area than do any of the inner ports 18. Each of the ports 12 may have substantially the same height as measured between the first major portion 81 and the second major portion 82 of the outer wall 80 due to the configuration of the tube 10, hence the cross-sectional flow areas of the first outermost port 14 and the second outermost port 16 may be increased or decreased relative to the inner ports 18 by increasing or decreasing a width of the first outermost port 14 and the second outermost port 16 relative to the inner ports 18. The first outermost port 14 and the second outermost port 16 may each accordingly have an outermost port width Wₒ that is greater or lesser in width than an inner port width Wᵢ of the inner ports 18.

In other embodiments, the outermost ports 14, 16 have the outermost port width Wₒ while each subsequent pair of ports 12 formed toward a center of the plurality of ports 12 has a width that is a ratio of the width of the ports 12 formed immediately exterior thereto, wherein the ratio may imply ports 12 that increase or decrease in cross-sectional flow area towards a center of the array of the ports 12. For example, with reference to the five ports 12 shown in FIG. 3, the outermost ports 14, 16 may have the outermost port width Wₒ, the ports 12 formed adjacent the outermost ports 12 may have a width that is a ratio of the outermost port width Wₒ, such as being three fourths (¾) the width of the outermost port width Wₒ, and the center port 12 may have a width that is a ratio of the ports 12 surrounding the center port 12, such as being nine sixteenths ( 9/16) of the width of the outermost port width Wₒ. In contrast, a width of each of the ports 12 may decrease in a direction towards the outermost ports 14, 16, as desired. It should be understood that the ports 12 formed in the tube 10 may have other configurations including a different port width for each of the ports 12 formed in the tube 10, as desired. Additionally, it should be understood that each of the ports 12 may have any suitable cross-sectional shape and arrangement while remaining within the scope of the invention, as desired.

The tube 10 includes a plurality of deformations or indentations 20 formed in the outer wall 80 thereof. The indentations 20 are portions of the outer wall 80 of the tube 10 that are deformed in a manner wherein each of the deformed portions extend at least partially into a hollow interior 13 of a corresponding one of the ports 12. Each of the indentations 20 may be formed in the outer wall 80 in a manner wherein each of the indentations 20 does not extend into the hollow interior 13 of more than one of the ports 12. The indentations 20 may be formed in the tube 10 in a plurality of linearly extending arrays separated from each other by one of the dividing walls 85 and correspond to one of the ports 12 formed in the tube 10.

The indentations 20 may have any suitable shape and form so long as each of the indentations 20 extends at least partially into the hollow interior 13 of one of the ports 12. With reference to FIGS. 2 and 3, at least one of the indentations 20 may have a perimeter 21 formed into a substantially circular or elliptical shape. However, each of the indentations 20 may instead be formed to have a perimeter 21 having any suitable shape, including rectangular shapes, hexagonal shapes, or irregular shapes, without departing from the scope of the present invention. Additionally, each of the indentations 20 may have a substantially arcuate cross-sectional shape as the deformed portion of the outer wall 80 extends into the hollow interior 13 of one of the ports 12, as best shown in FIG. 3. However, each of the indentations 20 may instead be formed to have any suitable cross-sectional shape, including substantially rectangular cross-sectional shapes, substantially trapezoidal cross-sectional shapes, and substantially triangular cross-sectional shapes, without departing from the scope of the present invention. The shape of the perimeter 21 and the cross-section of each of the indentations 20 may be selected to impart desirable flow characteristics of the first fluid as it flows through the tube 10, such as reducing a pressure drop incurred by the first fluid. In all cases, it may be advantageous to form each of the indentations 20 to have curvilinear and smooth transitions from one surface to another to prevent the formation of sharp edges within the hollow interior 13 of a corresponding one of the ports 12, as such sharp edges tend to promote a loss of pressure in a fluid as the fluid encounters the sharp edges.

The tube 10 may include both outer indentations 22 and inner indentations 24. The outer indentations 22 are those indentations 20 extending into the hollow interior 13 of each of the outermost ports 14, 16 in a direction parallel to the first major portion 81 and the second major portion 82. Accordingly, each of the outer indentations 22 may be formed as an inwardly deformed portion of one of the first short portion 83 or the second short portion 84 of the tube 10 extending in a direction toward the inner ports 18. In contrast, the inner indentations 24 are those indentations 20 extending into the hollow interior 13 of each of the inner ports 18 in a direction parallel to the first short portion 83 and the second short portion 84. Accordingly, each of the inner indentations 24 may be formed as an inwardly deformed portion of one of the first major portion 81 or the second major portion 82 of the tube 10 extending in a direction toward the other of the first major portion 81 and the second major portion 82.

FIGS. 2 and 3 illustrate the outer indentations 22 as deformed portions of the first short portion 83 and the second short portion 84 extending along an entirety of a height of the tube 10 measured from the first major portion 81 to the second major portion 82. Accordingly, the perimeter 21 of each of the outer indentations 22 illustrated in FIGS. 2 and 3 may be substantially rectangular in shape. In contrast, the inner indentations 24 are illustrated in FIGS. 2 and 3 as arcuate projections extending into the hollow interior 13 of each of the ports 12 and having a variable cross-section as each of the inner indentations 24 extends from one of the dividing walls 85 to an adjacent one of the dividing walls 85. Accordingly, as discussed hereinabove, the perimeter 21 of each of the inner indentations 24 may be substantially circular, elliptical, or rectangular, as non-limiting examples. However, it should be understood that the outer indentations 22 may instead be formed to resemble the inner indentations 24 without departing from the scope of the present invention. For example, each of the outer indentations 22 may extend further into the hollow interior 13 of the outermost ports 16 adjacent a central portion of the first short portion 83 and the second short portion 84 than at the first major portion 81 or the second major portion 84 in similar fashion as the inner indentations 24 extend into the inner ports 18. As such, the outer indentations 22 may include a perimeter 21 formed on one of the first short portion 83 or the second short portion 84 having a substantially circular, elliptical, or rectangular shape, as non-limiting examples. Additionally, it should also be understood that in some embodiments the outer indentations 22 may actually be formed in one of the first major portion 81 or the second major portion 82 adjacent the outermost ports 14, 16 instead of being formed in one of the first short portion 83 or the second short portion 84.

The indentations 20 may be arranged in the outer wall 80 of the tube 10 to have a pattern intended to promote the most efficient heat exchange between the first fluid flowing through the tube 10 and the second fluid flowing around the tube 10 while maintaining a desirable pressure and a flow rate of the first fluid through the tube 10. The spacing between adjacent ones of the indentations 20 may be selected to ensure that the heat exchange is substantially uniform throughout the tube 10 to prevent the formation of heightened thermal stresses at certain regions within the tube 10. For example, with reference to FIG. 2, the inner indentations 24 may be formed to have an alternating offset arrangement wherein the inner indentations 24 formed in one of the inner ports 18 are each spaced apart in a longitudinal direction of the tube 10 from the inner indentations 24 formed in an adjacent one of the inner ports 18. Additionally, the outer indentations 22 may be formed to be longitudinally offset from the inner indentations 24 of those inner ports 18 formed immediately adjacent the outermost ports 14, 16.

The inner indentations 24 may be formed in both the first major portion 81 and the second major portion 82 of the outer wall 80. For example, FIG. 3 illustrates a cross-section of the tube 10 having two of the inner indentations 24 formed in the first major portion 81 adjacent the outermost of the inner ports 18 and one of the inner indentations 24 formed in the second major portion 82 adjacent a central one of the inner ports 18. Accordingly, one or more of the inner indentations 24 formed in the first major portion 81 may be spaced apart in a longitudinal direction of the tube 10 from a corresponding one of the inner indentations 24 formed in the second major portion 82. This configuration causes the inner indentations 24 formed in the opposing major portions 81, 82 to not be longitudinally aligned with each other, thereby preventing the occurrence of the inner ports 18 having too great of a reduction in cross-sectional flow area that may negatively affect the flow characteristics of the first fluid. Additionally, the alternating of the inner indentations 24 being formed in either of the first major portion 81 and the second major portion 82 causes the first fluid to have a substantially undulating flow path through the tube 10. Alternatively, in some embodiments, each of the inner indentations 24 formed in the first major portion 81 may be formed to correspond to and be aligned longitudinally with one of the inner indentations 24 formed in the second major portion 82. In other words, the shape and arrangement of the inner indentations 24 formed in the first major portion 81 may be appear as a mirror image of the inner indentations 24 formed in the second major portion 82, as desired.

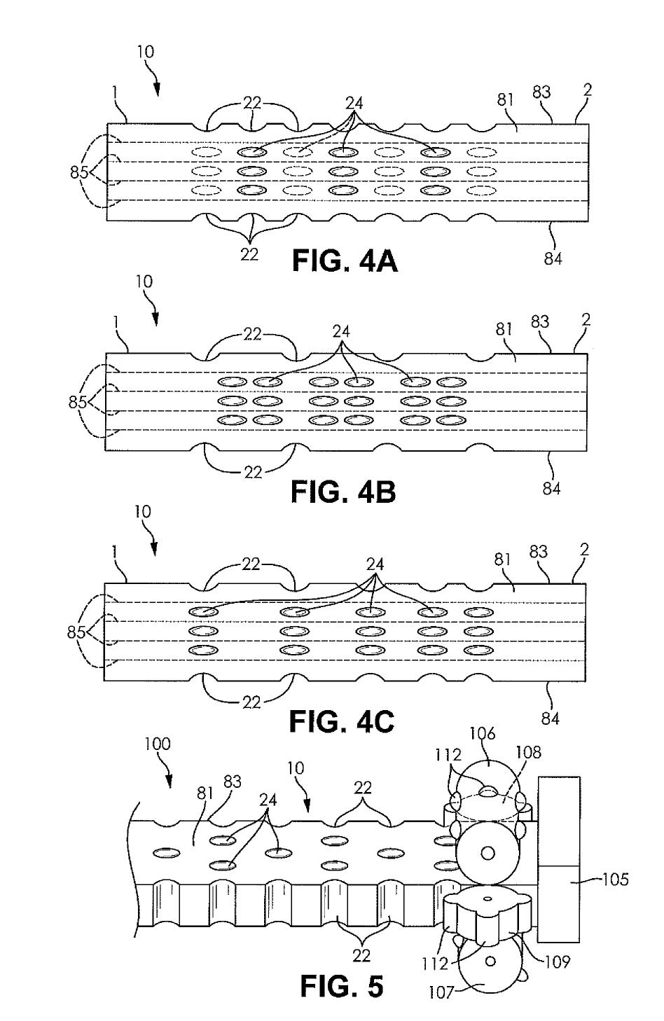

FIGS. 4A, 4B, and 4C illustrate several potential and non-limiting configurations of the indentations 20 formed in the tube 10. The tube 10 shown in FIG. 4A has a configuration wherein each pair of oppositely arranged outer indentations 22 formed in the first short portion 83 and the second short portion 84 are aligned in a longitudinal direction of the tube 10 with three of the inner indentations 24 formed in one of the first major portion 81 or the second major portion 82. The inner indentations 24 illustrated in FIG. 4A are formed in the first major portion 81 of the outer wall 80 while the elliptically shaped broken line patterns illustrated in FIG. 4A represent a position of the inner indentations 24 formed in the second major portion 82 of the outer wall 80.

FIG. 4B illustrates a configuration wherein a spacing between adjacent ones of the inner indentations 24 is variable in the longitudinal direction of the tube 10 while a spacing between adjacent ones of the outer indentations 22 is constant along a length of the tube 10. Accordingly, the tube 10 may include indentations 20 that are positioned to have a variable frequency of occurrence or the tube 10 may include inner indentations 24 that have a different frequency of occurrence than the outer indentations 22. Although not pictured in FIG. 4B, it should be understood that the inner indentations 24 formed in the second major portion 82 of the outer wall 80 may be aligned longitudinally with the inner indentations 24 formed in the first major portion 81 or may be spaced longitudinally therefrom in similar fashion to the arrangement illustrated in FIG. 4A, as desired.

FIG. 4C illustrates a configuration wherein each subsequent set of the indentations 20 in the longitudinal direction of the tube 10 is more closely spaced to an adjacent set of the indentations 20 as the tube 10 extends from the first end 1 to the second end 2 thereof. This form of variable spacing promotes increased turbulence within the tube 10 toward the second end 2 thereof, which aids in equalizing the degree of heat exchange occurring along a length of the tube 10. Although not pictured in FIG. 4C, it should be understood that the inner indentations 24 formed in the second major portion 82 of the outer wall 80 may be aligned longitudinally with the inner indentations 24 formed in the first major portion 81 or may be spaced longitudinally therefrom in similar fashion to the arrangement illustrated in FIG. 4A, as desired.

In use, the first fluid enters the inlet tank 6 of the heat exchanger 5 where the first fluid is distributed to each port 12 of each of the tubes 10 at the first end 1 thereof. The first fluid flows longitudinally through each of the tubes 10 to the second end 2 thereof and enters the outlet tank 7, wherein each independent flow of the first fluid through each of the ports 12 of the tubes 10 is recombined before exiting the heat exchanger 5. The first fluid is caused to change direction within the ports 12 each time the first fluid encounters and passes beyond each of the indentations 20 extending inwardly into each respective port 12. As the first fluid proceeds through each of the ports 12, the second fluid is caused to flow between each of the spaced apart tubes 10 to exchange heat with the first fluid via the outer wall 80 of each of the tubes 10. As shown in FIG. 1, the second fluid may also be caused to flow over or around a surface area increasing feature between adjacent ones of the tubes 10. The surface area increasing feature may be in the form of the plurality of alternatingly arranged fins 8, for example. The surface area increasing feature allows heat energy within the outer wall 80 of each of the tubes 10 to be further distributed through the surface area increasing feature to increase a total surface area of the components of the heat exchanger 5 exposed to and exchanging heat with the second fluid, thereby increasing a heat exchange efficiency of the heat exchanger 5.

The presence of the indentations 20 advantageously causes the heat exchanger 5 having the tubes 10 to have an increased heat exchange efficiency by increasing a turbulence of the first fluid as the first fluid proceeds through the ports 12 of the tube 10. The increased heat exchange efficiency occurs because a fluid having a laminar flow through a passageway such as one of the ports 12 tends to promote less heat transfer at the interior surface defining the passageway than does a fluid flowing therethrough having a turbulent flow. During laminar flow, the fluid tends to flow substantially parallel to the interior surface of the passageway forming the boundary layer, causing only that fluid immediately adjacent the boundary layer to exchange heat primarily via conductive heat transfer with the surface defining the passageway. The parallel flow leads to a lack of mixing of the fluid within the passageway, meaning that the amount of heat transfer occurring within the passageway is minimal. Accordingly, it can be beneficial to increase the turbulence of the flow through a heat exchanger passageway to increase the degree of mixing of the fluid, which can in turn promote heat transfer between the fluid within a central region of the passageway and the fluid at the boundary layer or may cause the fluid flowing through the central region of the passageway to be drawn to the boundary layer by the formation of eddies within the fluid flow.

The inclusion of the indentations 20 extending into the hollow interior 13 of each of the ports 12 causes the first fluid to repeatedly change direction each time the first fluid encounters and passes over one of the indentations 20, thereby promoting mixing of the first fluid as it proceeds through each change in direction. Portions of the first fluid may also strike the interior surface of each of the ports 12 as the first fluid strikes each of the indentations 20, thereby causing the first fluid at the boundary forming the interior surface of each of the ports 12 to further mix with the first fluid within a central region of each of the ports 12, thereby promoting additional mixing between different portions of the first fluid within each of the ports 12.

Referring now to FIG. 5, a system 100 for producing one of the tubes 10 is illustrated. The system 100 includes an extrusion die or fixture 105, a first deformation roller 106 disposed opposite a second deformation roller 107, and a third deformation roller 108 disposed opposite a fourth deformation roller 109. The extrusion die 105 may be any known form of device suitable for extruding material to have a predetermined cross-sectional shape based on a cross-sectional shape of the outlet of the extrusion die 105, for example. Accordingly, the extrusion die 105 may be configured to produce the main body of the tube 10 including the outer wall 80 and each of the dividing walls 85 during an extrusion process, thereby forming the array of linearly arranged ports 12 within each of the tubes 10. As should be understood, the extrusion die 105 may be configured to extrude material therefrom in a first direction extending parallel to the longitudinal axis of each of the tubes 10 as they are extruded from the extrusion die 105.

The first deformation roller 106 may abut the first major portion 81 of the outer wall 80 of the tube 10 and the second deformation roller 107 may abut the second major portion 82. An axis of rotation of both the first deformation roller 106 and the second deformation roller 107 may be arranged in a second direction perpendicular to the first direction the tube 10 is extruded from the extrusion die 105. The third deformation roller 108 may abut the first short portion 83 and the fourth deformation roller 109 may abut the second short portion 84. An axis of rotation of both the third deformation roller 108 and the fourth deformation roller 109 may be arranged in a third direction perpendicular to both the first direction and the second direction. The first deformation roller 106 and the second deformation roller 107 aid in constraining the tube 10 in the third direction during the extrusion process while the third deformation roller 108 and the fourth deformation roller 109 aid in constraining the tube 10 in the second direction.

Each of the deformation rollers 106, 107, 108, 109 includes at least one projection 112 extending therefrom for creating the indentations 20 in the outer wall 80 of the tube 10. As illustrated in FIG. 5, the first deformation roller 106 and the second deformation roller 107 may each include an annular array of the projections 112 formed on an outer circumferential surface thereof, wherein the projections 112 have a shape corresponding to a shape of each of the inner indentations 24 formed in either of the first major portion 81 or the second major portion 82. In order to produce a desired pattern of the inner indentations 24 in the tube 10, the projections 112 may be spaced apart from adjacent ones of the projections 112 in both the second direction and in a circumferential direction about the outer surface of either of the first deformation roller 106 and the second deformation roller 107. The third deformation roller 108 and the fourth deformation roller 109 may also each include an annular array of the projections 112 extending from an outer circumferential surface thereof for producing the outer indentations 22. As explained hereinabove, the outer indentations 22 may have a different configuration from the inner indentations 24. Accordingly, the projections 112 extending from either of the third deformation roller 108 or the fourth deformation roller 109 may have a different configuration from the projections 112 extending from either of the first deformation roller 106 or the second deformation roller 107. As shown in FIG. 5, the projections 112 formed in the third deformation roller 108 and the fourth deformation roller 109 may extend along an entirety of a height of the tube 10 in order to produce an outer indentation 22 in one of the first short portion 83 or the second short portion 84 extending from the first major portion 81 to the second major portion 82. However, it should be understood that the third deformation roller 108 and the fourth deformation roller 109 may instead include projections 112 having a shape and configuration resembling the projections 112 formed in either of the first deformation roller 106 or the second deformation roller 107 to produce any suitable pattern of indentations 20 in either of the first short portion 83 or the second short portion 84.

As shown in FIG. 5, the projections 112 formed on the outer circumferential surface of the second deformation roller 107 may be angularly offset with respect to the projections 112 formed on the outer circumferential surface of the first deformation roller 106. Such an arrangement may be used when the inner indentations 24 formed in the first major portion 81 are intended to be longitudinally spaced from the adjacent inner indentations 24 formed in the second major portion 82. However, it should be understood that the projections 112 may be arranged to have substantially the same angular position on each of the first deformation roller 106 and the second deformation roller 107 if it is desirable for the inner indentations 24 formed in the first major portion 81 to be longitudinally aligned with the inner indentations 24 formed in the second major portion 82. Additionally, the first deformation roller 106 and the opposing second deformation roller 107 are shown as being aligned in the first direction with the third deformation roller 108 and the fourth deformation roller 109, but it should be understood that each opposing pair of the rollers may be offset in the first direction, as desired, without departing from the scope of the present invention.

The deformation rollers 106, 107, 108, 109 are illustrated in FIG. 5 as extending through multiple full revolutions in order to produce the indentations 20 along a length of the tube 10. However, it should also be understood that rollers having a larger outer diameter and a greater quantity of the projections 112 formed on an outer circumferential surface thereof may be used, thereby allowing for each of the indentations 20 formed in one of the tubes 10 to be formed while each of the rollers undergo only one or fewer revolutions of the rollers. Such a configuration may be useful in producing a tube 10 having a variable spacing between adjacent ones of the indentations 20 in similar fashion to the tube 10 illustrated in FIG. 4C.

In use, the tube 10 is extruded from the extrusion die 105 in the first direction and towards each of the deformation rollers 106, 107, 108, 109. The deformation rollers 106, 107, 108, 109 constrain motion of the recently extruded tube 10 in both the second and third directions. The mechanical constraints placed on the tube 10 may be used to minimize any out of plane deformations of the tube 10 during formation of the indentations 20.

Each of the rollers 106, 107, 108, 109 is rotated about its respective axis of rotation to cause the outer circumferential surface of each of the rollers 106, 107, 108, 109 to move relative to the outer wall 80 of the tube 10. Each of the projections 112 encounters the outer wall 80 of the tube 10 as the rollers 106, 107, 108, 109 are rotated relative to the extruded tube 10. The projections 112 contact and apply a force to the outer wall 80 of the tube 10 to deform the outer wall 80 inwardly, thereby embossing each of the indentations 20 into the tube 10 to form the desired pattern of the indentations 20 in the outer wall 80 of each of the tubes 10.

It should be understood that the indentations 20 may also be introduced into the tube 10 at any time following the extrusion process thereof, including in a separate process not involving the system 100, so long as the indentations 20 are formed to create suitable flow characteristics within the tube 10 in the manner described hereinabove.

The introduction of the indentations 20 into the tube 10 allows for the tube 10 to be manufactured in a manner that is cost effective, less complex, and does not require the utilization of a separately manufactured insert or feature for use on or within the tube 10. The indentations 20 beneficially promote additional turbulence within the first fluid flowing through the ports 12 of the tube 10, which in turn improves a heat exchange efficiency of the tube 10. The size, shape, and frequency of the indentations 20 formed in the tube 10 may be selected to produce desirable flow characteristics within the ports 12 of the tube 10, including maximizing a flow rate therethrough, minimizing a pressure drop therein, and maximizing the degree of heat transfer therefrom.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A tube for a heat exchanger, the tube comprising:
a main body including an outer wall and a plurality of ports formed therein, each of the ports extending in a longitudinal direction from a first end of the main body to a second end thereof and configured to convey a first fluid therethrough, the outer wall of the main body including a surface deformation formed therein, wherein the surface deformation is a portion of the outer wall deformed inwardly into a hollow interior of one of the ports and configured to cause a turbulence of the first fluid as it flows from the first end to the second end of the main body.

2. The tube according to claim 1, wherein the outer wall of the main body has a substantially rectangular cross-sectional shape extending longitudinally from the first end to the second end including a first major portion arranged opposite and parallel to a second major portion and a first short portion arranged opposite and parallel to a second short portion, the first short portion and the second short portion connecting the first major portion to the second major portion.

3. The tube according to claim 2, wherein the surface deformation is a portion of the first major portion deformed inwardly in a direction toward the second major portion.

4. The tube according to claim 2, wherein the surface deformation is a portion of the first short portion deformed inwardly in a direction toward the second short portion.

5. The tube according to claim 2, wherein the surface deformation includes a plurality of indentations formed in the outer wall, the plurality of indentations including a first indentation formed in one of the first short portion and the second short portion and a second indentation formed in one of the first major portion and the second major portion.

6. The tube according to claim 5, wherein the plurality of ports includes a first port and a second port, the first indentation extending inwardly into the first port in a first direction and the second indentation extending inwardly into the second port in a second direction, the first direction arranged transverse to the second direction.

7. The tube according to claim 6, wherein the first port is disposed immediately adjacent one of the first short portion and the second short portion and the second port is disposed inwardly within the main body with respect to the first port.

8. The tube according to claim 1, wherein the surface deformation formed in the outer wall corresponds to and extends into only one of the plurality of ports formed in the main body.

9. The tube according to claim 1, wherein the main body is formed in an extrusion process and the surface deformation is mechanically introduced following the extrusion process.

10. The tube according to claim 1, wherein the surface deformation includes a plurality of indentations formed in the outer wall and the outer wall of the main body includes at least two perpendicularly arranged surfaces, each of the perpendicularly arranged surfaces including at least one of the indentations formed therein.

11. The tube according to claim 1, wherein the surface deformation includes a plurality of indentations formed in the outer wall, the plurality of indentations including a first indentation formed in a first portion of the outer wall and a second indentation formed in a second portion of the outer wall, wherein the first portion is arranged opposite the second portion and the first indentation and the second indentation each extend into a common one of the ports.

12. The tube according to claim 11, wherein the first indentation is spaced apart from the second indentation in the longitudinal direction of the common one of the ports.

13. A method of forming a tube comprising the steps of:
extruding a main body longitudinally in a first direction, wherein the extruding the main body includes a formation of at least one port therein for conveying a fluid through the main body; and
deforming at least a portion of an outer wall of the main body inwardly into one of the ports to form at least one indentation in the outer wall of the main body.

14. The method according to claim 13, wherein the deforming step is performed by a projection formed on an outer circumferential surface of a roller applying a force to the at least a portion of the outer wall.

15. The method according to claim 14, wherein the main body includes a plurality of the ports arranged in a row extending from a first outermost port to an oppositely arranged second outermost port, wherein the force is applied to a portion of the outer wall adjacent the first outermost port in a direction toward the second outermost port.

16. The method according to claim 14, wherein the main body includes a plurality of the ports arranged in a row extending from a first outermost port to an oppositely arranged second outermost port and including at least one inner port therebetween, wherein the force is applied to a portion of the outer wall adjacent the at least one inner port in a direction perpendicular to a direction the row of ports extends from the first outermost port to the second outermost port.

17. The method according to claim 13, further including a step of providing a first roller in contact with a first major portion of the outer wall and a second roller in contact with a second major portion of the outer wall, wherein the first major portion is arranged parallel to and opposite the second major portion.

18. The method according to claim 17, further including a step of providing a third roller in contact with a first short portion of the outer wall and a fourth roller in contact with a second short portion of the outer wall, wherein each of the first short portion and the second short portion connects the first major portion to the second major portion and wherein the first short portion is arranged parallel to and opposite the second short portion.

19. The method according to claim 18, wherein each of the first roller, the second roller, the third roller, and the fourth roller includes at least one projection formed on an outer circumferential surface thereof, wherein the at least one projection is configured to apply a force to the outer wall to form each of the indentations.

20. The method according to claim 18, wherein the first roller and the second roller deform the outer wall in a second direction perpendicular to the first direction and the third roller and the fourth roller deform the outer wall in a third direction perpendicular to each of the first direction and the second direction.
